(19) United States
(12) Patent Application Publication
(10) Pub. No.: US 2012/0308965 A1
(43) Pub. Date: Dec. 6, 2012

(54) Aircraft Maintenance Training Simulator Apparatus and Method

(75) Inventors: William Andrews, Orlando, FL (US); Joe Swinski, Lake Mary, FL (US); Darren Humphrey, Orlando, FL (US); Chris Van Duyne, Orlando, FL (US)

(73) Assignee: THE DISTI CORPORATION, Orlando, FL (US)

(21) Appl. No.: 13/153,985

(22) Filed: Jun. 6, 2011

(51) Int. Cl. G09B 9/00

(52) U.S. Cl. 434/30

(57) ABSTRACT

Disclosed is an aircraft maintenance training system to permit a student to simulate testing, repairing and maintaining components of an aircraft, the system comprising a database of components of the aircraft, an aircraft maintenance display to display a three-dimensional representation of the aircraft, a virtual cockpit display to display a representation of the controls of the aircraft and a processor to simulate operations of the components of the aircraft and allow the student to attach and remove components from the aircraft, and interface support equipment with the aircraft to read or modify characteristics of the components of the aircraft.

### TECHNICAL FIELD

This disclosure relates to an aircraft maintenance training simulator apparatus and method. More specifically, this disclosure relates to an aircraft maintenance training simulator comprising a database, a three-dimensional virtual aircraft maintenance display, and a two-dimensional virtual cockpit display.

### BACKGROUND OF THE INVENTION

Aircraft maintenance is a key requirement to maintaining safe operations in the sky. Similarly, our armed forces depend on the continuing functionality of military aircraft. But training aircraft maintenance personnel is a time intensive procedure, with different protocols for different aircraft. Furthermore, aircraft are expensive pieces of equipment, thus it is not always practical or cost-effective to allow for maintenance training to be performed on actual aircraft.

Virtual trainers are not new. For instance, U.S. Pat. No. 5,632,622 to Bothwell describes a method and apparatus for simulator control. The method and apparatus disclosed therein allows for quick and efficient changing of training scenarios. The aircraft is not presented in a virtual three dimensional representation to the student, and the student can not test and diagnose individual components of the aircraft using simulated testing equipment.

U.S. Pat. No. 5,147,206 issued to Golenski discloses a computerized system for training engine maintenance personnel. Automotive engine operations are simulated, and malfunctions can be induced. A trainee can then correct or adjust the components of the engine. The system and method disclosed therein does not operate on aircraft and does not provide a three-dimensional presentation of the vehicle to assist the student in learning. Furthermore, the individual components of the engine can not be removed, replaced, and tested to further narrow the maintenance exercise.

There exists a need in the industry to improve aircraft maintenance training and provide a method and system for training maintenance personnel how to test, repair, and maintain an aircraft and its components.

### SUMMARY OF THE INVENTION

According to one embodiment of the present disclosure, an aircraft maintenance training system is disclosed comprising a database, an aircraft maintenance display comprising a three-dimensional representation of an aircraft, a virtual cockpit display comprising a two-dimensional representation of the cockpit of the aircraft and a processor for simulating maintenance activities on the aircraft.

An advantage of the present disclosure is the ability to train aircraft maintenance personnel using a virtual three-dimensional representation of the aircraft and its components.

Another advantage of the present disclosure is the ability to train aircraft maintenance personnel in diagnosing, testing, and repairing individual components of an aircraft.

Another advantage of the present disclosure is the ability to train aircraft maintenance personnel in diagnosing, testing, and repairing individual components of an aircraft by using virtual support tools to test and report on the characteristics of components of an aircraft under different circumstances.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a block diagram illustrating one embodiment of an aircraft maintenance training system in accordance with the teachings of the present disclosure.

FIG. 2 is a diagram illustrating a compartment of a virtual three-dimensional aircraft displayed on an aircraft maintenance display.

FIG. 3 is a diagram illustrating a support equipment being used to probe a cable connection in accordance with the teachings of the present disclosure.

FIGS. 4a, 4b, and 4c are diagrams of a pin probe being used to probe cable connections.

FIG. 5 is a diagram of a component of the virtual cockpit being removed so as to expose the component interface to the student.

FIG. 6 is a diagram of a suspension and stores interface in accordance with the teachings of the present disclosure.

FIG. 7 is a diagram of the interior of a virtual three-dimensional aircraft on the aircraft maintenance display depicting airflows within the cabin.

FIG. 8 is a block diagram illustrating an alternate embodiment of an aircraft maintenance training system in accordance with the teachings of the present disclosure.

FIG. 9 is a block diagram illustrating an alternate embodiment of an aircraft maintenance training system in accordance with the teachings of the present disclosure.

Similar reference characters refer to similar pars throughout the several views of the drawings.

### DETAILED DESCRIPTION OF THE DRAWINGS

The present disclosure relates to an aircraft maintenance training simulator. More particularly, the aircraft maintenance training simulator disclosed herein comprises a database, an aircraft maintenance display, a virtual cockpit display, and a processor for simulating operations of an aircraft and its components in order to train a student in aircraft maintenance.

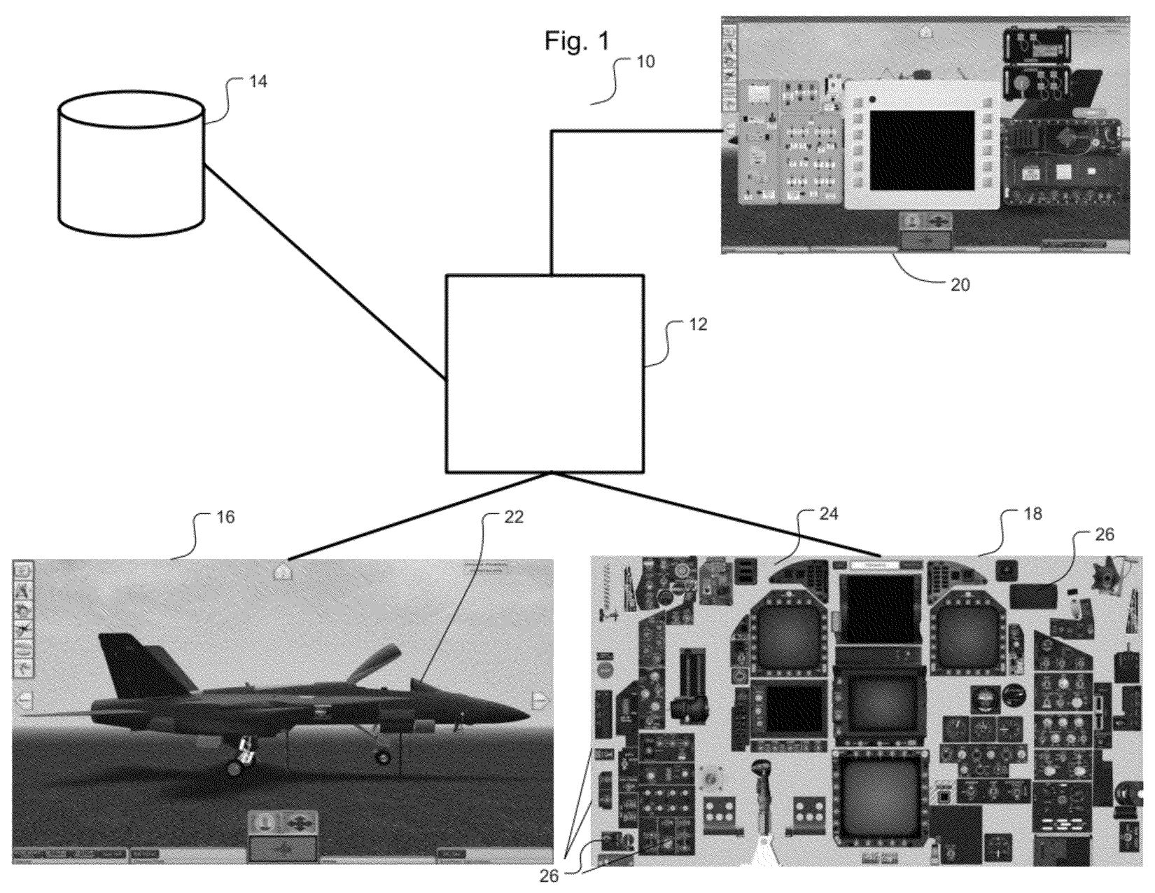

FIG. 1 is an illustration of the aircraft maintenance training system disclosed herein in a preferred embodiment. The system 10 comprises a processor 12, a database 14, an aircraft maintenance display (“AMD”) 16, and a virtual cockpit display (“VCD”) 18. Also depicted in FIG. 1, and discussed below, is an equipment tray 20.

The aircraft maintenance training system 10 is a Virtual Maintenance Training Environment (“VMTE”). While described in detail here in terms of an aircraft maintenance training system, it would be readily apparent to one of skill in the art that the teachings disclosed herein can be used for training maintenance personnel on any type of machinery that requires maintenance. This would include engines, industrial machines, automobiles, spacecraft, boats, computers, watches, and the like.

The processor 12 can be any computer processor or processing unit. The processor 12 can be a single central processing unit, or a number of processing units configured to operate either in sequence or in parallel. The processor 12 can be configured to execute software processes which implement features of the system 10. The processor 12 can also be communicatively coupled with a memory (not depicted) for storing instructions for the processor 12 to execute. The memory may be any computer memory capable of storing the steps necessary for the processor 12 to implement the features of the system 10 disclosed herein.

The database 14 may be any system for storing information. In a preferred embodiment, the database 14 is a relational database for storing information concerning components 26 of the aircraft 22. The information may include mechanical and electrical characteristics for each component. The information may include details concerning the size, shape, functionality, interfaces, and connectivity of the respective component.

The information stored in the database 14 is used by the system 10 to generate the three-dimensional aircraft 22. By having this detailed information about each component 26 of the aircraft 22, the system 10 can permit full three-dimensional modeling of the aircraft 22, allowing a student to walk around the virtual aircraft 22, open compartments 28 on the aircraft 22, remove and replace components 26, remove and test components 26, and all other procedures that would typically be performed by maintenance personnel.

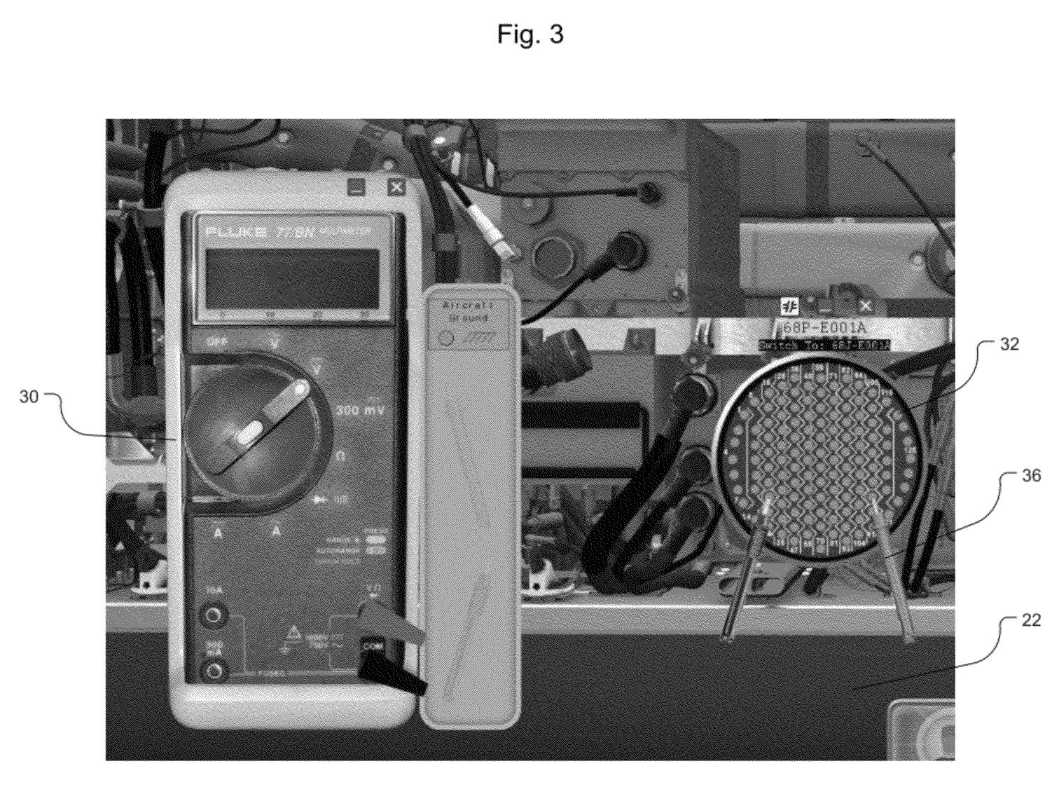

By storing the electrical and mechanical characteristics of the components 26 in the database 14, the system 10 can train the student on how to properly test the individual components using the proper support equipment 30 from the equipment tray 20. For instance, as depicted in FIG. 3, and discussed in more detail below, the student can select a support equipment (a multimeter in the example depicted in FIG. 3), and attach its probes 36 to appropriate locations in a component 26 (a cable in the example depicted in FIG. 3).

The information stored in the database may also include physical constraints for the components. The physical constraints may be defined by actions being constrained by conditions. Each object may have a list of possible actions and a list of possible conditions. Physical constraint checking may occur when a user attempts to perform an action. The system 10 may consult the list of conditions and determine if they have been satisfied. If so, the action may be permitted. However, if a condition is not satisfied, the system 10 will prevent the action.

Returning to FIG. 1, the AMD 16 is the interface through which the student can see a three-dimensional representation of the aircraft 22 the student is working on. Preferably, the three-dimensional aircraft 22 is generated based on information in multiple data sources (not depicted). These data sources can be stored in the database 14, or can be stored elsewhere. The data used to generate the three-dimensional aircraft 22 can include Computer Aided Design (“CAD”) data. In a preferred embodiment, CAD formats include CATIA, Unigraphics (NX), ProE, and AutoCAD.

The data can also include high resolution photographs, existing three-dimensional Studio Max models. In a preferred embodiment, the data can also include Reuseable Software Objects (“RSOs”) from the DiSTI® GL Studio®. Additionally, the data can include drawings, manuals, systems and subsystem specifications.

The use of high-resolution photographs is beneficial in adding photo-realistic details to the three-dimensional aircraft 22 model presented in the AMD 16.

The three-dimensional aircraft 22 presented in the AMD 16 allows the student to navigate around the aircraft 22 in all three dimensions. As the student approaches the aircraft 22 using the AMD 16, the system 10 will preferably lower the “eye point” or focus the student sees in the AMD 16, so that the user essentially ducks under the aircraft 22. The AMD 16 also preferably includes a home button (or other similar control) to return the student's viewpoint to an initial viewpoint. Similarly, the system may also re-orient the student's viewpoint if the student moves too far from the aircraft 22.

The system may also incorporate an aircraft checks algorithm enabling auto-navigation to predefined locations based upon standard aircraft checks procedures. For example, the following schema may be used in such an approach:

```
<?xml version=″1.0″ encoding=″utf-8″?>
<xs:schema targetNamespace=″http://tempuri.org/XMLSchema.xsd″
elementFormDefault=″qualified″
xmlns=″http://tempuri.org/XMLSchema.xsd″
xmlns:mstns=″http://tempuri.org/XMLSchema.xsd″
xmlns:xs=″http://www.w3.org/2001/XMLSchema″>
  <xs:element name=″CheckList″ type=″ListOfSteps″>
  </xs:element>
  <xs:complexType name=″ScreenLocation″>
    <xs:complexContent>
      <xs:restriction base=″xs:anyType″>
        <xs:sequence>
          <xs:element name=″X″ type=″LocValRelative″ />
          <xs:element name=″Y″ type=″LocValRelative″ />
        </xs:sequence>
      </xs:restriction>
    </xs:complexContent>
  </xs:complexType>
  <xs:complexType name=″ViewVec″>
    <xs:sequence>
      <xs:element name=″Location″ type=″Coords″ />
      <xs:element name=″Direction″ type=″Coords″ />
    </xs:sequence>
  </xs:complexType>
  <xs:complexType name=″Coords″>
    <xs:sequence />
    <xs:attribute name=″X″ type=″xs:float″ />
    <xs:attribute name=″Y″ type=″xs:float″ />
    <xs:attribute name=″Z″ type=″xs:float″ />
  </xs:complexType>
  <xs:complexType name=″View″>
    <xs:choice>
      <xs:element name=″Name″ type=″xs:string″ />
      <xs:element name=″ViewVector″ type=″ViewVec″ />
    </xs:choice>
  </xs:complexType>
  <xs:complexType name=″StepInfo″>
    <xs:sequence>
      <xs:element name=″Viewpoint″ type=″View″ minOccurs=″0″
maxOccurs=″1″>
      </xs:element>
      <xs:element name=″Topic″ type=″xs:string″ minOccurs=″0″
maxOccurs=″1″ />
      <xs:element name=″Instruction″ type=″xs:string″
minOccurs=″0″ maxOccurs=″1″ />
      <xs:element name=″DiagLoc″ type=″ScreenLocation″
minOccurs=″0″ maxOccurs=″1″ />
      <xs:element name=″ValidStepConditionVariable″
type=″xs:string″ minOccurs=″0″ maxOccurs=″1″ />
      <xs:element name=″ValidStepConditionValue″
type=″xs:string″ minOccurs=″0″ maxOccurs=″1″ />
      <xs:element name=″SubSteps″ type=″ListOfSteps″
minOccurs=″0″ maxOccurs=″1″ />
    </xs:sequence>
    <xs:attribute name=″nonNumbered″ type=″xs:boolean″ />
  </xs:complexType>
  <xs:complexType name=″ListOfSteps″>
    <xs:sequence>
      <xs:element name=″Step″ type=″StepInfo″ minOccurs=″0″
maxOccurs=″unbounded″ nillable=″true″ />
    </xs:sequence>
  </xs:complexType>
  <xs:simpleType name=″LocValRelative″>
    <xs:restriction base=″xs:float″>
      <xs:minInclusive value=″0.0″ />
      <xs:maxlnclusive value=″1.0″ />
    </xs:restriction>
  </xs:simpleType>
</xs:schema>
```

An exemplary aircraft checks algorithm utilizing the above schema could be driven by next and previous buttons. With each step through, the student's eyepoint would be moved to the location and direction specified. Additionally, the ValidStepConditionVariable could be consulted to determine if steps should automatically be skipped. Checks which do not apply to the current aircraft configuration could be avoided. For example, the student would not be prompted to check the missile launchers on an aircraft if none are installed.

The AMD 16 also preferably includes an indicator showing the student which direction the student is facing, as well as which angle the student is viewing the aircraft 22 at.

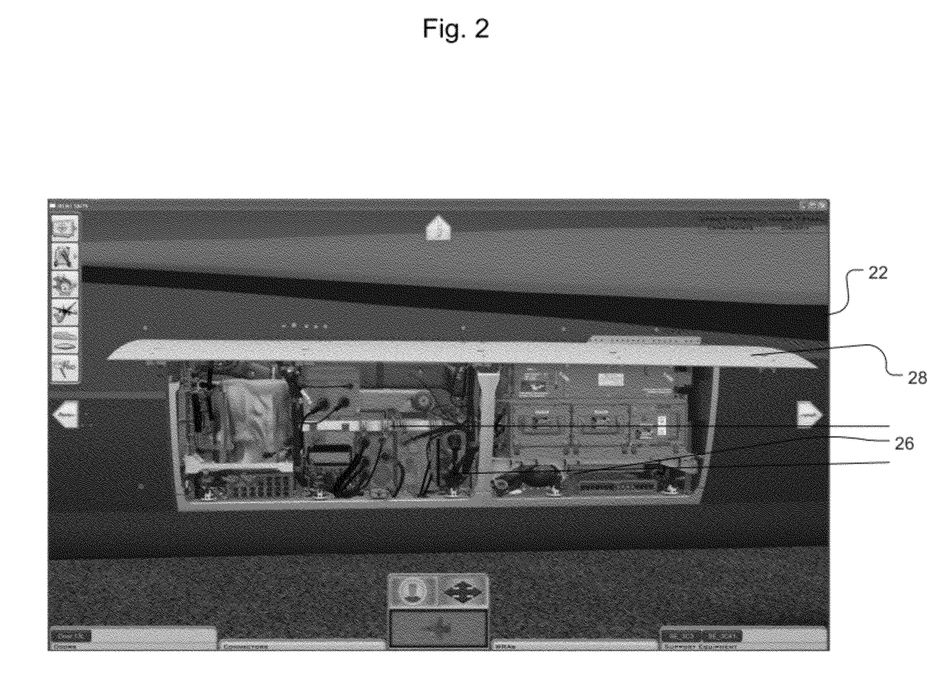

As the student approaches various components 26 of the aircraft 22, the student can perform various tasks. The tasks that the student can perform are determined by the system 10 based upon the information stored about the component 26 in the database 14. For example, turning to FIG. 2, as the student approaches a compartment 28 of the aircraft 22, the student can open the compartment 28 to work on the components 28 therein. It should be noted that a compartment 28 of the aircraft is one type of component 26 of the aircraft 22 stored in the database 14. Thus, the information stored in the database 14 concerning the compartment 28 depicted in FIG. 2 informs the system 10 that the student can open and close the compartment 28.

Once the compartment 28 is opened, the focal point presented to the student in the AMD 16 in an ideal view. Thus, each time a student opens the compartment 28, the student is presented with the same preferable view of the compartment 28. This improves student training under the system 10 because all students learning to maintain the equipment in the particular compartment 28 will be presented with the same initial view of that compartment 28.

The system 10 may also include a segmented taskbar (depicted along the bottom of the AMC 16). This segmented taskbar can assist the student effectively track opened doors, disconnected connectors, removed assemblies, and opened, but minimized support equipment. The taskbar also may provide the student the ability to return to previously opened doors and to reinstall removed items.

As the student navigates closer to the aircraft 22, specialized markers can be displayed allowing the student to delve deeper into the aircraft 22. This may be necessary when there are areas to be maintained, for instance, which are difficult to present through the walking algorithms used to navigate around the aircraft 22. This enables the student to view larger details of smaller components 26 in the aircraft 22.

The system 10 can also provide the student capabilities to quickly move to a particular component 26. For instance, the system 10 can present a list of doors and compartments 28. Once selected by the student, the system 10 can position the student at the selected compartment 28 to enable the user to practice maintenance procedures therein.

Returning to FIG. 1, the VCD 18 may include a two-dimensional representation of a virtual cockpit 24 of the aircraft 22. Each control of the aircraft 22 can be stored in the database 14 as a component 26 of the aircraft 22. The student is able to utilize the controls of the aircraft 22 to control the aircraft 22. For instance, if the student pulls the flight stick back, the student can see the elevator flaps elevate on the aircraft 22 in the AMD. This allows the student to learn to diagnose malfunctions with various controls.

In a preferred embodiment, the components 26 depicted in the VCD 18 are generated from high resolution digital photographs for the panels, controls, displays, and instruments. These images can be stored in any data store, including the database 14. These images can be any digital image format, including Joint Photographic Experts Group (jpeg), Portable Network Graphics (png), Graphics Interchange Format (gif), Bitmap (bmp), Photoshop Document (psd), Portable Document Format (pdf), Tagged Image Format (tif), or raw image. Preferably, images are stored as raw image data.

In an alternate embodiment, the system 10 can use other two-dimensional data to generate the virtual cockpit 24 displayed in the VCD 18. This other two-dimensional data can include scaled technical drawings and technical manuals.

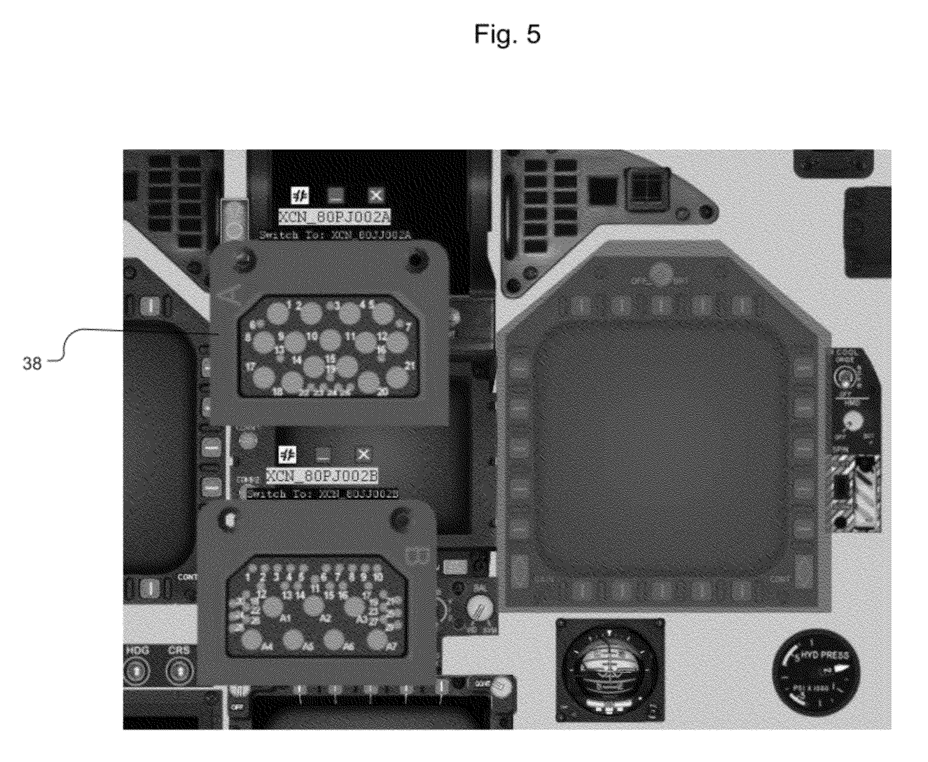

Through the VCD 18, the student can operate the various controls, as mentioned above. Additionally, the student can remove the controls to perform maintenance procedures. For example, FIG. 5 depicts an interface that can display when the student removes a component 26 from the virtual cockpit 24. By consulting the database 14, the system 10 would present the appropriate interface to the student. As depicted in FIG. 5, the component 26 removed is identified in the database 14 as a probe-able component 26. Thus, an appropriate component interface 38 is presented to the student. The student can then connect appropriate support equipment 30 (for instance, the multimeter depicted in FIG. 3) to test the connectors on the component 26. While the student has the support equipment 30 connected, the student can operate the component (i.e. adjust the switches, alter the knobs, and so forth). The system 10 will simulate the performance of the component and the support equipment 30 will display appropriate information.

For instance, if the support equipment 30 is a multimeter, the display can present current and resistance through the component 26 as simulated by the system 10. Thus, if the system 10 is simulating a defective component 26, the student can discover that defect by utilizing the appropriate support equipment 30. Furthermore, the student can then remove the component 26 and replace it with a new component 26 to see if that repairs the maintenance condition.

Returning to the VCD 18 depicted in FIG. 1, in a preferred embodiment, the student can select one or more components 26 and drag them to the AMD 16. Preferably, the components 26 are enlarged during this process to ease their viewability. The student can then utilize these components 26 in the AMD 16 to see the impact they have on the aircraft 22.

Some components 26 may have a substantial amount of detail, and therefore benefit from displaying special views of those components 26. For instance, the system 10 may include a stick special view for showing enhanced characteristics of the flight stick for the aircraft 22. There may also be special views for the rudder pedals, throttle, or any other component of the aircraft 22.

FIG. 1 also depicts an equipment tray 20. The equipment tray 20 can be displayed on any interface to the student, including the AMD 16 and VCD 18. Alternatively, an additional display (not depicted) can be used to display the equipment tray 20 to the student. In another embodiment, the equipment tray 20 is a physical tray or cart that the student has access to. In such an embodiment, the support equipment 30 on the equipment tray 20 would be communicatively coupled to the system 10 so that the student can physically simulate maintenance procedures (such as attaching a meter to a cable) and have the equipment function as disclosed herein. The communication between the support equipment 30 and the system 10 could be any known communication protocol, including TCP/IP, WiFI, Bluetooth, or any other communication protocol.

Returning to the virtual equipment tray 20 depicted in FIG. 1, the tray 20 can include virtual representations for any type of equipment which would be used in maintaining an aircraft. The support equipment 30 is simulated by the system 10 to support maintenance, testing, and troubleshooting. The database 14 can have information defining the capabilities for each piece of support equipment 30.

The system 10 may include support equipment 30 which does not attach directly to the aircraft 22. For instance, support equipment 30 can include power carts, cooling carts, and the like.

The system 10 may also include three different types of support equipment 30: Active in two-dimensions, Instant Install; and Drag to Install. Support equipment 30 which is active in two-dimensions can appear in two-dimensions on the AMD 16, and float on top of the three-dimension screen presented in the AMD 16. These types of support equipment 30 can come in three sub types: probes that attach in 2D, probes that drop into the 3D scene, and no probes. Probes which attach in 2D (such as depicted in FIG. 3), can be fully functional probes, which attach to appropriate probing faces on appropriate components 26. In a preferred embodiment, the student drags and drops virtual probes or connectors, which “snap” to the nearest pin or connector on the probable face of the component 26.

The system may determine an appropriate drop spot when a student attempts to drop a probe after dragging it to a particular location. First, the system would determine a list of drop spots which are applicable to the probe. For each of the listed drop spots, the system may make a check based upon whether the drop spot is a three-dimensional drop spot or a two-dimensional drop spot. For a three-dimensional drop spot, the system may exclude drop spots that are outside a logical units radius specified for the probe. For a two-dimensional drop spot, the system may exclude drop spots that are outside the screen space units (for instance, pixels) specified by the probe. Furthermore, for two-dimensional drop spots with the same parent, the system may favor objects drawn later since those objects are most likely to be visible.

Once the list of drop spots has been established, the system may sort those drop spots in depth order and choose the drop spot closest to the viewer.

An example probe that may drop into the 3D scene could be an external power control panel. Using such a panel, the student would drag and drop the external power connector into the 3D scene in the AMD 16 to connect it to the aircraft 22.

For support equipment 30 with no probes, the student selects the equipment and it preferably is placed in the AMD 16 in the appropriate location. For instance, if the student selects a jack as the support equipment 30, the system 10 preferably places the jack in an appropriate location under the aircraft 22. The system 10 may then present the student with a control for raising and lowering the jack.

For support equipment 30 which is Instant Install, the system 10 automatically performs the function associated with the support equipment 30 on the AMD. For example, if the support equipment 30 is an AOA Vane cover, the system 10 would automatically install that cover on the aircraft when the student selects it.

Drag to install support equipment 30 requires the student to drag the equipment 30 into the appropriate place on the AMD 16.

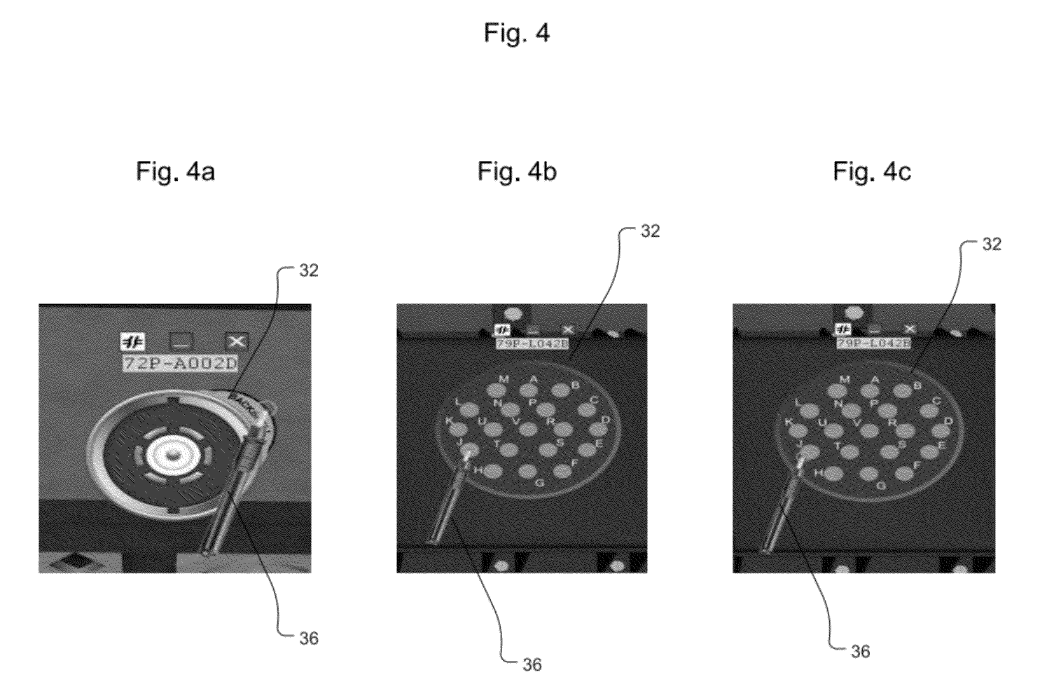

One example maintenance activity the student can perform is to remove, test, and replace a cable. The student would do this by viewing the cable in the AMD 16, and selecting it. Once selected, the student can be presented with an option to remove it. The system 10 consults the database 14 to determine if the component 26 (the cable in this example) is probe-able. If so, the student is presented with an appropriate interface (such as depicted in FIGS. 4a-c) for testing.

FIG. 4a-c depicts the testing of a virtual cable in accordance with the present disclosure in more detail. As depicted therein, the probe 36 of a support equipment 30 (for instance, a multimeter) is connected with a backshell (FIG. 4a), center pine (FIG. 4b), and outer shield (FIG. 4c). This allows a high level of granularity in the tests that a student can perform on a particular component 26.

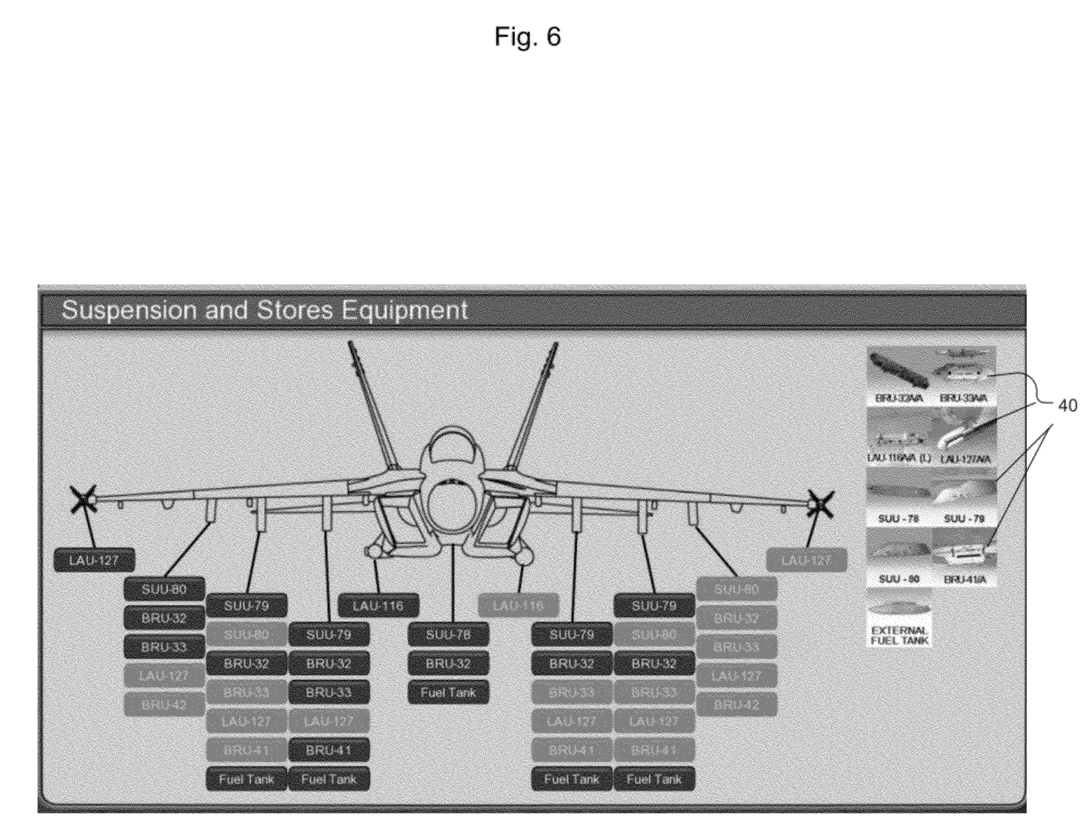

Turning next to FIG. 6, the student can install and remove various equipment 40 to and from the aircraft 22. The system 10 will verify that only appropriate configurations are done by the student. Through this display (an example of which is depicted in FIG. 6), the student is presented with a selector for the suspension equipment and weapons selection, which is shown with icons stacked based upon their physical relationship. The user must select the icons in the correct order of their physical relationship, or the student will be unable to install them. The system may present the student with appropriate notification of installation failure, such as by playing a clanking sound.

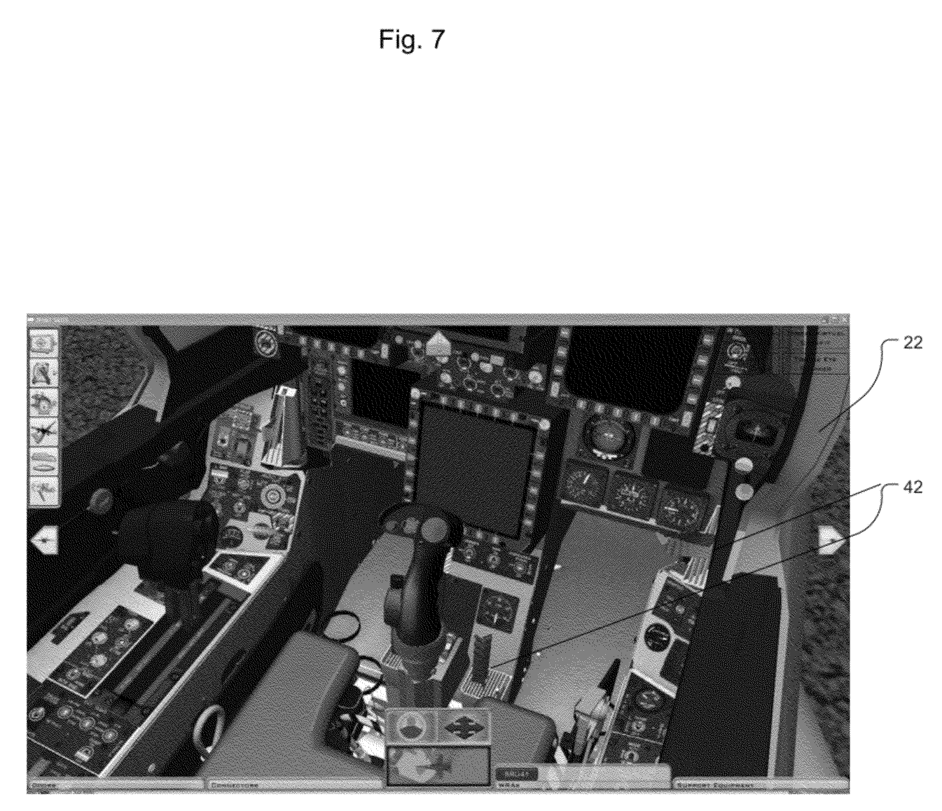

FIG. 7 depicts yet another functionality the system 10 may implement to help train the student in maintenance procedures. The system 10 can display airflow information 42 in appropriate locations of the aircraft 22. The airflow information 42 can provide the student with information on simulated air temperature, velocity, and direction. In a preferred embodiment, the airflow information 42 is depicted with different colors and sizes representing the respective temperature, direction and velocity. This can give the student a quick representation of the airflow in a particular compartment. As the system 10 simulates the operation of the aircraft 22, the airflow information 42 will change accordingly. Thus, as a student manipulates components 26 that impact airflow, the student will see the results of that manipulation in realtime.

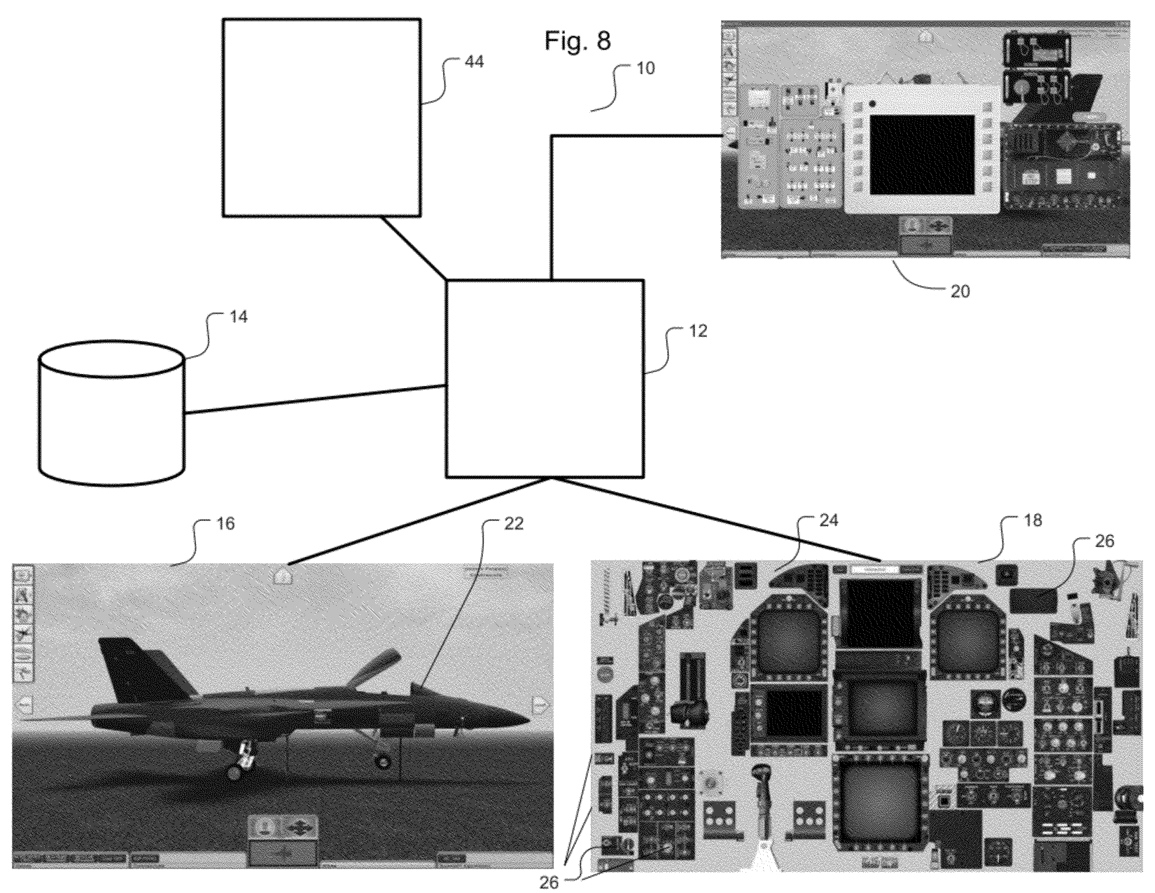

FIG. 8 depicts the system 10 in an alternate embodiment. The alternative embodiment depicted in FIG. 8 includes a processor 12, a database 14, an AMD 16, a VCD 18, an equipment tray 20, and a cockpit 44. The cockpit 44 is preferably a physical representation of the cockpit of the actual aircraft 22. In this embodiment, the system 10 maintains a correspondence between the state of controls in the cockpit 44 and their virtual representations in the virtual cockpit 24 displayed in the VCD 18. Thus, for example, when an operator flips a switch in the cockpit 44, the virtual cockpit 24 is updated to reflect that change. In a preferred embodiment, the virtual cockpit 24 can highlight that change to the student. For instance, the virtual cockpit 24 can place a highlighted box around a component 26 that has changed in the cockpit 44. This highlighted box can be displayed for a preconfigured (or adjustable) amount of time, such as 1 second. If multiple actions take place in the cockpit, then multiple highlight boxes can be displayed in the virtual cockpit 24.

The system 10 can also simulate the lighting of the aircraft 22. This simulation can include lighting within a compartment 28, including the main cabin. This lighting can include floodlights, utility light, chart light, and console lighting. Both day/night and night vision lighting can be simulated. Panel front and back lighting can also be simulated. The simulation can include exterior lighting of the aircraft 22.

The virtual cockpit 24 can be placed into a passive mode, so that only commands executed in the cockpit 44 impact the performance of the aircraft 22.

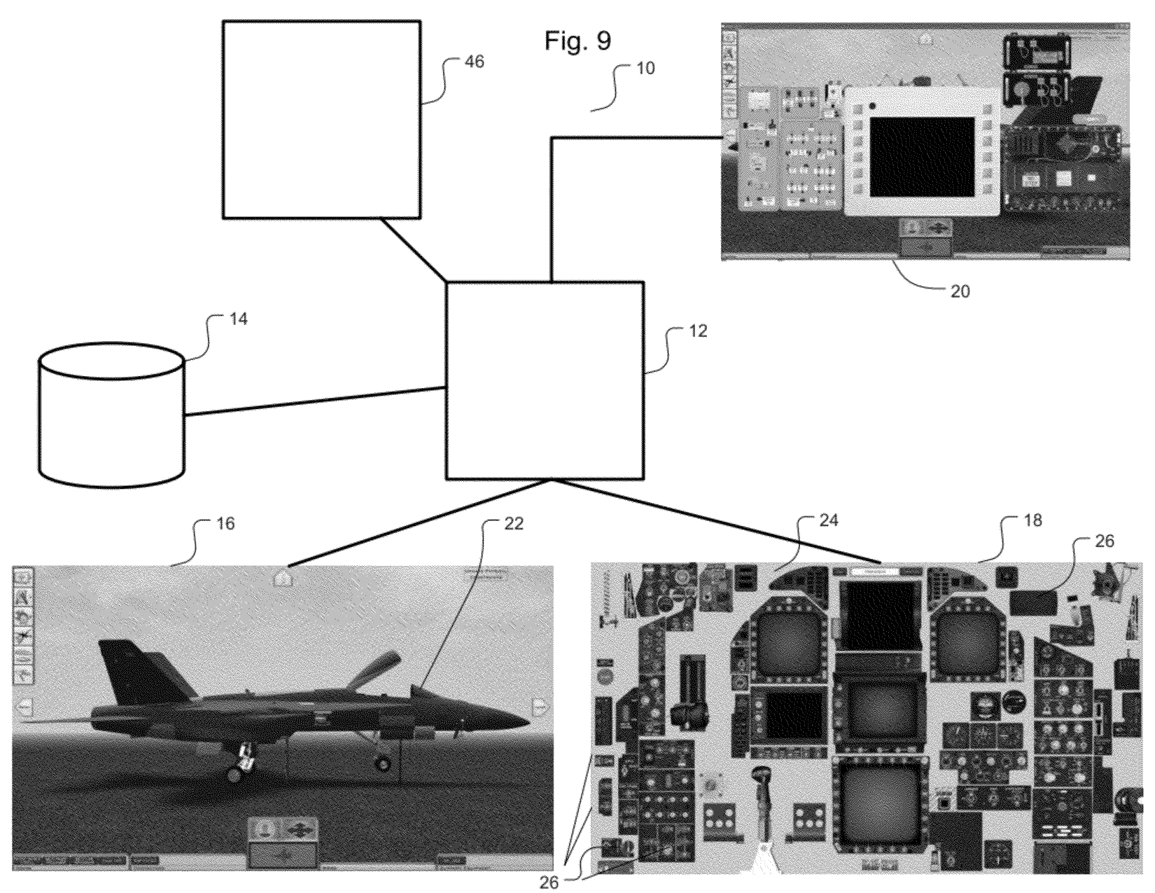

FIG. 9 depicts another alternate embodiment of the system disclosed herein. The alternative embodiment depicted in FIG. 9 includes a processor 12, a database 14, an AMD 16, a VCD 18, an equipment tray 20, and an instructor interface 46. As would be evident to one of skill in the art, the embodiment shown in FIG. 8 can be combined with that shown in FIG. 9, so that a cockpit 44 can also be included.

The instructor interface 46 permits an instructor to monitor and control a maintenance procedure being performed by a student. The system 10 may present caution and warning information to either the student or the instructor or to both. The instructor interface 46 may permit the instructor to pause the simulation, or to restart it. The instructor interface 46 can be any device adaptable to be connected to the system, including a personal computer, laptop, personal digital assistant, smartphone, or any other device which can be connected. In a preferred embodiment, the instructor interface 46 is connected to the system 10 via a network, either wired or wireless.

In a preferred embodiment, the AMD 16 and VCD 18 are each presented on large, high definition digital displays. Preferably, each display is full 1080 p high definition. In a preferred embodiment, the system 10 is built on the Microsoft Windows® platform, and uses the enhanced desktop feature to utilize multiple displays. In an alternate embodiment, the AMD 16 and VCD 18 are presented on a single display.

The system 10 can be implemented on one or more computing systems, which can include a personal computer, a workstation, a network computer, hand held device, or any other suitable processing device. Further, the system 10 can be written as a software program in any appropriate computer language, such as, for example, C, C++, C#, Java, Assembler, Tcl, Lisp, Javascript, or any other suitable language. In one embodiment, the system 10 is implemented as a web-based application.

The system 10 may also include a student orientation capability. An example schema used for this capability is below:

```
<?xml version=″1.0″ encoding=″utf-8″ ?>
<xs:schema targetNamespace=″http://tempuri.org/XMLSchema.xsd″
elementFormDefault=″qualified″
  xmlns=″http://tempuri.org/XMLSchema.xsd″
xmlns:mstns=″http://tempuri.org/XMLSchema.xsd″
  xmlns:xs=″http://www.w3.org/2001/XMLSchema″>
  <xs:element name=″OrientationSteps″
type=″ListOfSteps″></xs:element>
  <xs:simpleType name=″Degrees″>
    <xs:restriction base=″xs:unsignedInt″>
      <xs:minInclusive value=″0″ />
      <xs:maxExclusive value=″360″ />
    </xs:restriction>
  </xs:simpleType>
  <xs:complexType name=″ScreenLocation″>
    <xs:complexContent>
      <xs:restriction base=″xs:anyType″>
        <xs:sequence>
          <xs:element name=″X″ type=″LocValRelative″
/>
          <xs:element name=″Y″ type=″LocValRelative″
/>
        </xs:sequence>
      </xs:restriction>
    </xs:complexContent>
  </xs:complexType>
  <xs:complexType name=″ViewVec″>
    <xs:sequence>
      <xs:element name=″Location″ type=″Coords″ />
      <xs:element name=″Direction″ type=″Coords″ />
    </xs:sequence>
  </xs:complexType>
  <xs:complexType name=″Coords″>
    <xs:sequence />
    <xs:attribute name=″X″ type=″xs:float″ />
    <xs:attribute name=″Y″ type=″xs:float″ />
    <xs:attribute name=″Z″ type=″xs:float″ />
  </xs:complexType>
  <xs:complexType name=″View″>
    <xs:choice>
      <xs:element name=″Name″ type=″xs:string″ />
      <xs:element name=″ViewVector″ type=″ViewVec″ />
    </xs:choice>
  </xs:complexType>
  <xs:complexType name=″Target″>
    <xs:choice>
      <xs:element name=″ObjectName″ type=″xs:string″ />
      <xs:element name=″TargetLoc″ type=″Coords″ />
    </xs:choice>
  </xs:complexType>
  <xs:complexType name=″PointTarget″>
    <xs:sequence>
      <xs:element name=″PointTo″ type=″Target″ />
      <xs:element name=″Offset″ type=″Coords″
minOccurs=″0″ maxOccurs=″1″/>
    </xs:sequence>
  </xs:complexType>
  <xs:complexType name=″Condition″>
    <xs:sequence>
      <xs:element name=″ConditionBoolean″ type=″xs:string″
minOccurs=″0″/>
      <xs:element name=″StepExitVariable″ type=″xs:string″
/>
      <xs:element name=″StepExitInitialValue″
type=″xs:string″ minOccurs=″0″/>
      <xs:element name=″StepExitValue″ type=″xs:string″/>
    </xs:sequence>
  </xs:complexType>
  <xs:complexType name=″StepInfo″>
    <xs:sequence>
      <xs:element name=″Viewpoint″ type=″View″
minOccurs=″0″ maxOccurs=″1″></xs:element>
      <xs:element name=″Topic″ type=″xs:string″
minOccurs=″0″ maxOccurs=″1″ />
      <xs:element name=″Instruction″ type=″xs:string″
minOccurs=″0″ maxOccurs=″1″ />
      <xs:element name=″DiagLoc″ type=″ScreenLocation″
minOccurs=″0″ maxOccurs=″1″ />
      <xs:element name=″HandPointTo″ type=″PointTarget″
minOccurs=″0″ maxOccurs=″1″ />
      <xs:element name=″HandPointDir″ type=″Degrees″
minOccurs=″0″ maxOccurs=″1″ />
      <xs:element name=″HandPointDelay″ type=″xs:float″
minOccurs=″0″ maxOccurs=″1″ />
      <xs:element name=″TouchAreaWidth″ type=″xs:float″
minOccurs=″0″ maxOccurs=″1″ />
      <xs:element name=″TouchAreaHeight″ type=″xs:float″
minOccurs=″0″ maxOccurs=″1″ />
      <xs:element name=″ArrowPointTo″ type=″PointTarget″
minOccurs=″0″ maxOccurs=″1″ />
      <xs:element name=″PointTargetDir″ type=″Degrees″
minOccurs=″0″ maxOccurs=″1″ />
      <xs:element name=″ArrowPointDelay″ type=″xs:float″
minOccurs=″0″ maxOccurs=″1″ />
      <xs:element name=″StepCondition″ type=″Condition″
minOccurs=″0″ maxOccurs=″2″ />
      <xs:element name=″PickList″
type=″ListOfPickableObjects″ maxOccurs=″1″
minOccurs=″0″></xs:element>
      <xs:element name=″NonPickList″
type=″ListOfPickableObjects″ maxOccurs=″1″
minOccurs=″0″></xs:element>
      <xs:element name=″SetResourceValue″ type=″xs:string″
minOccurs=″0″ maxOccurs=″1″ />
      <xs:element name=″SubSteps″ type=″ListOfSteps″
minOccurs=″0″ maxOccurs=″1″ />
    </xs:sequence>
    <xs:attribute name=″nonNumbered″ type=″xs:boolean″ />
  </xs:complexType>
  <xs:complexType name=″ListOfSteps″>
    <xs:sequence>
      <xs:element name=″Step″ type=″StepInfo″
minOccurs=″0″ maxOccurs=″unbounded″ nillable=″true″ />
    </xs:sequence>
  </xs:complexType>
  <xs:simpleType name=″LocValRelative″>
    <xs:restriction base=″xs:float″>
      <xs:minInclusive value=″0.0″ />
      <xs:maxlnclusive value=″1.0″ />
    </xs:restriction>
  </xs:simpleType>
  <xs:complexType name=″ListOfPickableObjects″>
    <xs:sequence>
      <xs:element name=″PickObject″ type=″xs:string″
minOccurs=″0″ maxOccurs=″unbounded″ />
    </xs:sequence>
  </xs:complexType>
</xs:schema>
```

The orientation steps could control a hand and a pointer, or other similar identifier. These can point to items in both 2D and 3D, and the steps stored can determine what to point to and when to point to it. Furthermore, the orientation steps can specify which specific objects are “pickable.” By “pickable,” the object is determined to be available to the student. Thus, the system 10 can be configured to limit which objects the user can interact with on a per-step basis.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. An aircraft maintenance training system to permit a student to simulate testing, repairing, and maintaining components of an aircraft, the system comprising:
a database of all components of the aircraft, wherein the database includes mechanical or electrical characteristics for each component of the aircraft;
an aircraft maintenance display (“AMD”) operable to display a virtual three-dimensional representation of the aircraft and a virtual three-dimensional representation of the components of the aircraft, the AMD permitting the student to simulate the testing, repairing, and maintaining of the displayed components;
a virtual cockpit display (“VCD”) operable to display a two-dimensional representation of the controls of the aircraft, whereby when the student adjusts the controls of the aircraft in the VCD, the virtual three-dimensional representation of the aircraft in the AMD is altered to reflect the student's adjustment;
a virtual support equipment tray operable to display available support equipment accessories which the student can use to test, repair, and maintain components of the aircraft; and
a processor communicatively connected to the database, AMD, and VCD executing software which simulates operations of the components of the aircraft and allows the student to attach components to the aircraft, remove components from the aircraft, and interface a support equipment accessory with a selected component of the aircraft to read or modify the mechanical or electrical characteristics of the component.

2. An aircraft maintenance training system, the system comprising:
a database of at least one component of an aircraft;
an aircraft maintenance display (“AMD”) operable to display a representation of the aircraft and at least one component of the aircraft;
a virtual cockpit display (“VCD”) operable to display a representation of the controls of the aircraft; and
a processor coupled to the database, AMD and VCD, executing software which simulates operations of at least one component of the aircraft and allows a student to perform maintenance operations on the aircraft.

3. The system of claim 2 wherein the maintenance operation is attaching a component to the aircraft.

4. The system of claim 2 wherein the maintenance operation is removing a component from the aircraft.

5. The system of claim 2 wherein the maintenance operation is testing a component of the aircraft.

6. The system of claim 5 wherein testing the component of the aircraft is performed using a virtual testing device.

7. The system of claim 5 wherein testing the component of the aircraft is performed using a physical testing device whereby the physical testing device is communicatively connected to the system.

8. The system of claim 2 wherein the processor simulates airflow within the aircraft.

9. The system of claim 2 wherein the processor simulates lighting conditions of the aircraft.

10. The system of claim 2 wherein the AMD displays a three-dimensional representation of the aircraft.

11. The system of claim 2 further comprising:
a cockpit.

12. The system of claim 11 wherein actions taken in the cockpit are reflected in the AMD and the VCD.

13. The system of claim 12 wherein the processor receives communications from the cockpit, and sends communications to the AMD and the VCD.

14. The system of claim 1 further comprising:
an instructor interface.

15. The system of claim 14 wherein the instructor interface can control at least one operation of the simulation.

16. A method for training an aircraft maintenance student by simulating testing, repairing, and maintaining components of an aircraft, the method comprising the following steps:
interfacing the student with an aircraft maintenance training system, wherein the aircraft maintenance training system comprises a database, an aircraft maintenance display (“AMD”), a virtual cockpit display (“VCD”), and a processor;
displaying a three-dimensional representation of the aircraft to the student in the AMD, and a two-dimensional representation of the controls of the aircraft in the VCD using the processor;
receiving input from the student in either the AMD or the VCD, wherein the student selects a component of the aircraft to maintain;
determining from the database what maintenance operations the student can perform on the selected component; and
simulating a maintenance operation on the selected component.

17. The method of step 16 further comprising the step of:
simulating a malfunction condition in the aircraft prior to receiving input from the student.

18. The method of step 17 wherein simulating a malfunction condition is initiated in an instructor interface connected to the aircraft maintenance training system.

19. The method of step 16 further comprising the steps of:
receiving input from a user in a cockpit, wherein the cockpit is connected to the aircraft maintenance training system.

20. The method of step 19, further comprising the step of
altering the representation of the three-dimensional aircraft in the AMD in response to the input received from the user in the cockpit.
